(19) United States
(12) Patent Application Publication
(10) Pub. No.: US 2012/0257723 A1
(43) Pub. Date: Oct. 11, 2012

(54) ELECTRON BEAM GENERATOR AND X-RAY GENERATOR INCLUDING THE SAME

(75) Inventors: Il-hwan KIM, Seoul (KR); Yong-chul KIM, Seoul (KR); Jeong-na HEO, Hwaseong-si (KR); Joon-won BAE, Seoul (KR); Sung-hoon PARK, Seoul (KR)

(73) Assignee: SAMSUNG ELECTRONICS CO., LTD., Suwon-si (KR)

(21) Appl. No.: 13/439,456

(22) Filed: Apr. 4, 2012

(30) Foreign Application Priority Data
Apr. 7, 2011 (KR) 10-2011-0032191

(51) Int. Cl. H01J 35/14; H01J 9/18; H01J 3/14

(52) U.S. Cl. 378/138; 250/396 R; 445/28

(57) ABSTRACT

An electron beam generator includes a cathode electrode; and a first insulating layer, a gate, a second insulating layer and a focusing gate sequentially on the cathode electrode. The cathode electrode, the first insulating layer, the gate, the second insulating layer and the focusing gate are individually separable from each other and combinable with each other.

### CROSS-REFERENCE TO RELATED APPLICATIONS

This application claims priority to Korean Patent Application No. 10-2011-0032191, filed on Apr. 7, 2011, and all the benefits accruing therefrom under 35 U.S.C. §119, the disclosure of which is incorporated herein in its entirety by reference.

### BACKGROUND

1. Field

Provided are embodiments of electron beam generators and X-ray generators including the same, and more particularly, embodiments of electron beam generators that include an assembly in which components of the electron beam generators may be readily assembled and disassembled, and X-ray generators including the same.

2. Description of the Related Art

Electron beam generators are used in various fields. For example, an electron beam generator is used as an electron supply apparatus in an X-ray generator. The X-ray generator may have a configuration including an anode electrode and an electron beam generator.

Electron beam generators include cold cathode electron beam generators and hot cathode electron beam generators, and are used in many fields. Many studies have been conducted to commercialize cold cathode electron beam generators that use field emission.

### SUMMARY

Provided are electron beam generators that include an assembly in which components of the electron beam generators may be readily assembled with and disassembled from each other, and X-ray generators including the same.

Additional aspects will be set forth in part in the description which follows and, in part, will be apparent from the description, or may be learned by practice of the presented embodiments.

Provided is an electron beam generator including, a cathode electrode, and a first insulating layer, a gate, a second insulating layer and a focusing gate sequentially on the cathode electrode in the stated order. The cathode electrode, the first insulating layer, the gate, the second insulating layer and the focusing gate are individually separable from each other and combinable with each other.

The electron beam generator may further include an assembling unit which aligns and fixes the cathode electrode, the first insulating layer, the gate, the second insulating layer and the focusing gate with respect to each other.

The assembling unit may include lateral supporting units on the cathode electrode, and an upper supporting unit on the focusing gate. The upper supporting unit is in separable connection with the lateral supporting units.

The electron beam generator may further include an alignment unit which aligns the cathode electrode, the first insulating layer, the second insulating layer and the focusing gate with respect to each other.

The alignment unit may be on at least one of the cathode electrode, the first insulating layer, the gate, the second insulating layer and the focusing gate.

The alignment unit may include alignment marks. The alignment marks of the alignment unit may include a groove.

The alignment unit may include a plurality of alignment marks on the cathode electrode, and through holes in the first insulating layer, the gate, the second insulating layer and the focusing gate respectively aligned with the alignment marks on the cathode electrode.

Provided is an X-ray generator including a container unit including a window on a side of the container unit; an electron beam generation unit in the container unit; and an anode which generates X-rays due to the electron beam generated from the electron beam generation unit. The X-rays are emitted to an outside of the container unit through the window, and the electron beam generation unit includes the electron beam generator described above.

### BRIEF DESCRIPTION OF THE DRAWINGS

These and/or other aspects will become apparent and more readily appreciated from the following description of the embodiments, taken in conjunction with the accompanying drawings of which:

FIG. 1 a cross-sectional view of an electron beam generator according to an embodiment of the present invention;

FIG. 2A is a perspective view of an electron beam generator according to another embodiment of the present invention;

FIG. 2B is an exploded perspective view of the electron beam generator of FIG. 2A, according to an embodiment of the present invention;

FIG. 2C is a plan view of a focusing gate including alignment marks, that is, alignment surfaces for assembling constituent elements of an electron beam generator according to an embodiment of the present invention;

FIGS. 3A and 3B are a plan view and a cross-sectional drawing showing an assembling unit, that is, alignment marks for aligning constituent elements of an electron beam generator according to an embodiment of the present invention; and

FIG. 4 is a cross-sectional view of an X-ray generator including an electron beam generator according to an embodiment of the present invention.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the description.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

Generally, an electron beam generator is operated in a vacuum state. A gate electrode and a focusing electrode of a conventional field emission electron beam generator device are formed by using thin film or thick film deposition technology. As such, component elements of the electron beam generator may not be separable from each other. For example, an electron beam generator may be contaminated by a gas during operation, and as a result, an arcing phenomenon may be caused in a specific region, or an electron beam generation unit, an insulating layer or an electrode may be damaged, thereby reducing the operation performance of the electron beam generator. However, since component elements of the electron beam generator may not be separable from each other, it is difficult to repair or replace the contaminated or damaged component element.

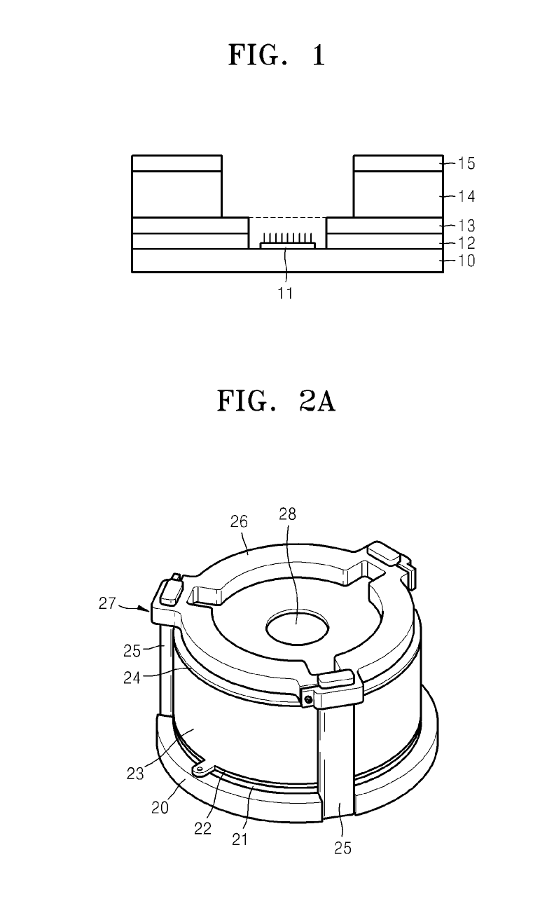

FIG. 1 a cross-sectional view of an embodiment of an electron beam generator according to the present invention.

Referring to FIG. 1, a cathode electrode 10 used in generating an electron beam is provided. An electron generation unit 11 may be on a region of the cathode electrode 10, for example, on a central region of the cathode electrode 10. A first insulating layer 12 may be around the electron generation unit 11 on the cathode electrode 10, in a plan view of the cathode electrode 10. A gate 13 for controlling the flow of electrons generated from the cathode electrode 10 and the electron generation unit 11 may be on the first insulating layer 12. A second insulating layer 14 may be on the gate 13, and a focusing gate 15 for focusing an electron beam may be on the second insulating layer 14.

All of the cathode electrode 10, the first insulating layer 12, the gate 13, the second insulating layer 14 and the focusing gate 15 included in the electron beam generator are able to be assembled with and disassembled from each other. Thus, the embodiment of the electron beam generator according to the present invention may further include an assembling unit for use in assembling constituent elements and/or an alignment unit for use in aligning the constituent elements of the electron beam generator with respect to each other.

The cathode electrode 10, the gate 13, and the focusing gate 15 may include a material such as a metal or a conductive metal oxide that is used to form conventional electronic devices. In one or more embodiments, for example, the metal may be Ti, Pt, Ru, Au, Ag, Mo, Al, W, Cu, or a conductive metal oxide, or a combination thereof. The electron generation unit 11 is a material layer that generates electrons by a power applied from the cathode electrode 10. In one or more embodiments, for example, the electron generation unit 11 may be a region including carbon nanotubes (“CNTs”). The first insulating layer 12 and the second insulating layer 14 may include an insulating material used to form conventional semiconductor devices. More specifically, the first insulating layer 12 and the second insulating layer 14 may each independently include SiO₂, HfO₂, Al₂O₃, or Si₃N₄ as a material with a high dielectric constant (otherwise referred to as a high-K material). The material of the first insulating layer 12 and the second insulating layer 14, e.g., HfO₂, Al₂O₃, or Si₃N₄, may have a dielectric constant which is greater than that of SiO₂. Also, a combination comprising at least one of the foregoing materials may be used.

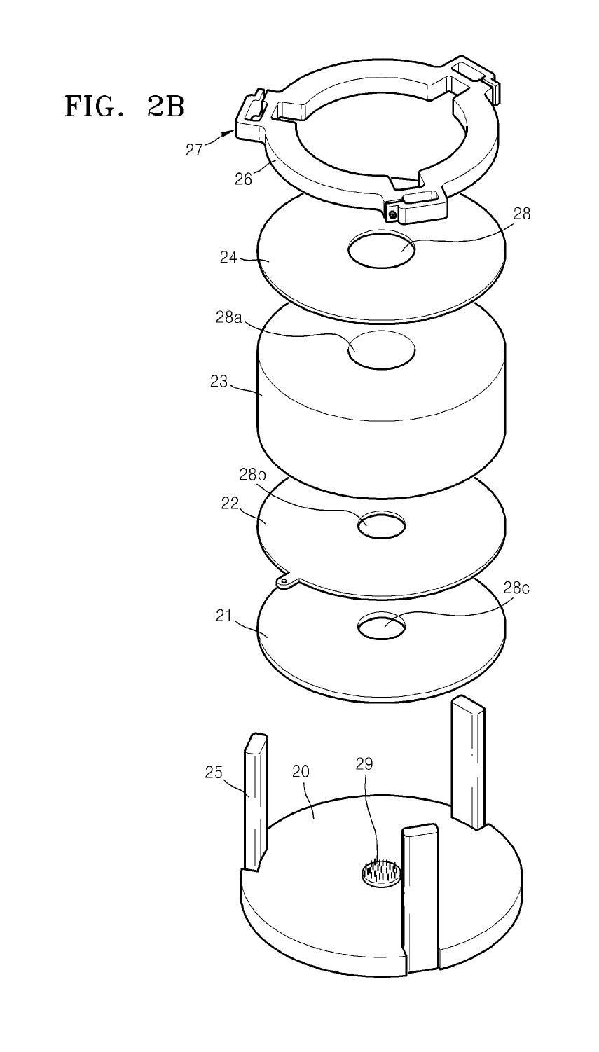

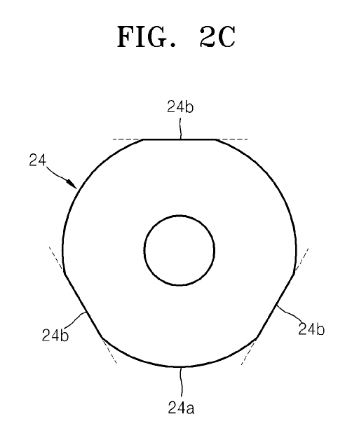

In FIG. 2A, the constituent elements of an electron beam generator, having an oval shape or a circular shape in the plan view, are depicted as an example. However, the constituent elements may have any shape without limitations. In one or more embodiments, for example, the constituent elements may have a polygonal structure such as a square shape or a pentagon shape.

FIG. 2B is an exploded perspective view of the embodiment of the electron beam generator of FIG. 2A, according to the present invention. The electron beam generator may further include an assembling unit for assembling constituent elements of the electron beam generator of FIG. 1.

Referring to FIG. 2B, as described with reference to FIG. 1, a cathode 20, a first insulating layer 21, a gate 22, a second insulating layer 23 and a focusing gate 24 may be sequentially fixed in the stated order, such as by the assembling unit. The assembling unit may include lateral supporting units 25 fixed on the cathode electrode 20, and an upper supporting unit 26 on an upper surface of the focusing gate 24. The upper supporting unit 26 is separable and connectable to the lateral supporting units 25. The first insulating layer 21, the gate 22, the second insulating layer 23 and the focusing gate 24 may respectively include holes 28c, 28b, 28a and 28 in the centers thereof, to discharge and control electrons generated from an electron generation unit 29 on an upper surface of the cathode electrode 20. The cathode electrode 20 may not include a hole.

The upper supporting unit 26 includes fixing members 27 at an outer surface of the upper supporting unit 26. Each of the fixing members 27 includes protruded portions extended directly from the outer surface of the upper supporting unit 26 and a first opening in which a distal end of a lateral supporting unit 25 is inserted, as illustrated in FIG. 2A. The first opening is defined by the protruded portions and the outer surface of the upper supporting unit 26. The fixing members 27 and a remainder of the upper supporting unit 26 collectively form a single, unitary indivisible member.

The first opening is accessible from an outside of the fixing member 27 by a second opening which is continuous from the first opening to the outside of the fixing member 27. One of the protruded portions is deformable away from the outer surface of the upper supporting unit 26, such that the second opening is widened and the first opening accommodates dimensions of the lateral supporting unit 25 therein. When the deformed protruded portion returns to its original state, the lateral supporting unit 25 is effectively surrounded by the fixing members 27 and held in the first opening, such that the constituent elements the cathode 20, the first insulating layer 21, the gate 22, the second insulating layer 23 and the focusing gate 24 are in alignment with each other. A fixing member may secure the fixing member 27 proximate to the second opening, to the remainder of the upper supporting unit 26. The respective holes 28c, 28b, 28a and 28 in the centers the constituent elements may also be aligned when the lateral supporting unit 25 is in the fixing member 27.

The lateral supporting unit 25 and the upper supporting unit 26 are removably and detachably disposed with each other, such that individual constituent components of the electron beam generator may be assembled with and disassembled from each other. In the case that separate and individual constituent elements of an electron beam generator form an assembly so that the separate and individual constituent elements are readily separable from and attachable to each other, when a specific element malfunctions due to, for example, contamination, only the corresponding element may be readily removed and replaced.

When the embodiment of the electron beam generator is formed by assembling constituent elements, the degree of focusing and a final beam of an electron beam may vary according to the alignment of the electron generation unit 29 and the focusing gate 24. Therefore, the alignment of the constituent elements is important. In order to readily align the constituent elements, the constituent elements may include structures having various shapes of alignment units when the constituent elements are formed. In one or more embodiments, for example, an alignment mark may be on each of the constituent elements to use when the constituent elements are assembled into the electron beam generator. The alignment mark may be a groove to use when upper and lower layers are assembled. At least two alignment marks may be on each of the constituent elements, and the type of the alignment mark is not limited. Also, the alignment mark may be a hole to insert additional pins not only for the purpose of aligning.

FIG. 2C is a plan view of an embodiment of the focusing gate 24 including alignment marks. The alignment marks are alignment surfaces for assembling constituent elements of an embodiment of an electron beam generator according to the present invention.

Referring to FIG. 2C, an external surface or edge of the focusing gate 24 may include a curved surface 24a and a linear alignment surface 24b which alternate with each other. The linear alignment surfaces 24b of the focusing gate 24 contact the lateral supporting units 25 and extend as a substantially straight line between adjacent curved surfaces 24a, to correspond to surfaces of the lateral supporting units 25 of the assembling unit. In this way, the external shape of one or more embodiments of the electron beam generator according to an the present invention may match with the shape of the assembling unit, and may have a cross-section of a polygonal structure such as a mesh shape that does not include a curved surface to readily align constituent elements.

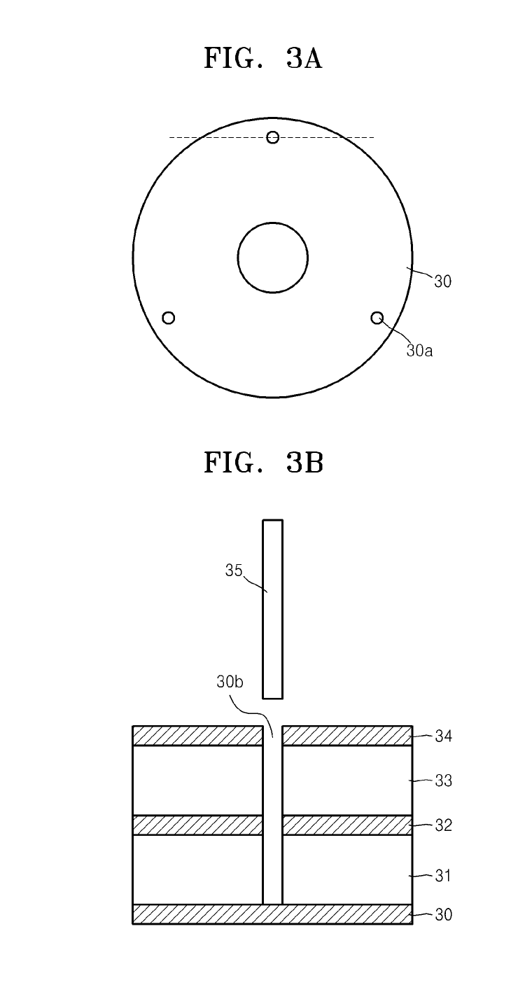

FIGS. 3A and 3B are a plan view and a cross-sectional view showing an embodiment of an alignment unit. The alignment unit includes alignment marks 30a for aligning constituent elements of one or more embodiments of an electron beam generator according to the present invention. The alignment unit may be in at least one constituent element of an embodiment of the electron beam generator according to the present invention, and each of the constituent elements may include at least two alignment units.

Referring to FIG. 3A, the alignment marks 30a may be on a cathode electrode 30 of the electron beam generator. Here, both the cathode electrode 30 and the alignment marks 30a are depicted having a circular planar shape. However, an alignment mark 30a may have various shapes, such as a polygonal shape. The alignment marks 30a may be not only on the cathode electrode 30 but also on a first insulating layer 31, a gate 32, a second insulating layer 33 and/or a focusing gate 34 on the cathode electrode 30.

Also, referring to FIG. 3B, through holes 30b may be in the first insulating layer 31, the gate 32, the second insulating layer 33 and the focusing gate 34 sequentially stacked and assembled on the cathode electrode 30, at positions corresponding to the positions of the alignment marks 30a of the cathode electrode 30, in the plan view of the stacked elements. Constituent elements may be readily aligned and assembled by inserting, for example, pins 35 through the through holes 30b.

In the case that separate and individual constituent elements of an electron beam generator that is used for an X-ray generator are fixed together to form an assembly so that the separate and individual constituent elements are readily separable from and attachable to each other, when a specific element malfunctions due to, for example, contamination, only the corresponding element may be readily removed and replaced.

Also, when an operation condition of the electron beam generator needs to be changed, simply controlling a voltage of the focusing gate 34 may be difficult to effect a change in the operation condition, and thus, thicknesses of insulating layers and electrodes may also need to be changed. In this case, according to one or more embodiments of the present invention, an element that needs to be changed may be simply removed from the assembly and another element having different dimensions may be readily replaced.

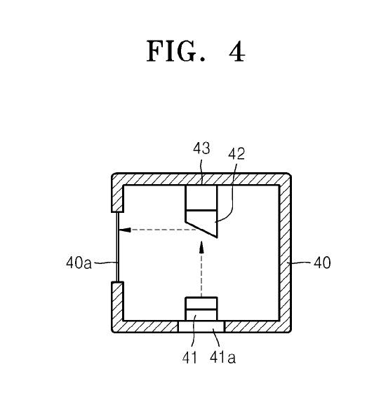

FIG. 4 is a cross-sectional view of an embodiment of an X-ray generator including an electron beam generator 41 according to an embodiment of the present invention.

Referring to FIG. 4, the X-ray generator includes a container unit 40, the electron beam generator 41 in the container unit 40, and an anode 43 that transforms an electron beam generated from the electron beam generator 41 to X-rays. The X-ray generator also includes a window 40a on a side of the container unit 40, through which X-rays are emitted to the outside.

The container unit 40 may have any shape as long as the container unit 40 may maintain the inner space thereof in a vacuum state. The container unit 40 may further include a venting unit (not shown) connected to an external vacuum pump to vent an inner gas to the outside out of the container unit 40. The container unit 40 may include a material that may shield X-rays, for example, stainless steel (“SUS”) or glass. When the container unit 40 includes glass, the container unit 40 may further include an X-ray shielding material, for example, lead (Pb) or a heavy metal, to additionally shield X-ray. The window 40a may include an X-ray transmitting material, for example, pyrex glass or aluminum (Al) that maintains the inner space of the container unit 40 in a vacuum state and may emit X-rays to the outside of the container 40.

The electron beam generator 41 may include characteristics of one or more embodiments of an electron beam generator according to the present invention. The X-ray generator and/or the electron beam generator 41 may include a fixing unit 41a on which the electron beam generator 41 is mounted. The fixing unit 41a may be assembled and disassembled to and from the container unit 40. Thus, when a specific element of the electron beam generator 41 is contaminated or malfunctioned, only the corresponding element of the electron beam generator 41 may be readily removed and replaced.

The anode 43 generates X-rays due to an electron beam generated from the electron beam generator 41 and may include a target 42 formed of a metal, wherein the metal may be Mo, Ag, W, Cr, Fe, Co, Cu, or a metal alloy, or a combination thereof. The electron beam generator 41 and the anode 43 may be respectively connected to external power supply units.

According to one or more embodiments of present invention, there are provided an electron beam generator in which, if a specific constituent element malfunctions due to contamination, only the corresponding constituent element may be readily removed and replaced, and an X-ray generator that includes the electron beam generator.

While the present invention has been shown and described with reference to embodiments thereof, it should not be construed as being limited to such embodiments. Those who are skilled in this art, for example, acknowledge electron beam generators that include various types of aligning shapes and X-ray generators according to the spirit of the present invention. Therefore, the scope of the invention is not defined by the detailed description of the invention but by the appended claims.

What is claimed is:

1. An electron beam generator comprising:
a cathode electrode; and
a first insulating layer, a gate, a second insulating layer and a focusing gate sequentially on the cathode electrode,
wherein the cathode electrode, the first insulating layer, the gate, the second insulating layer and the focusing gate are individually separable from each other and combinable with each other.

2. The electron beam generator of claim 1, further comprising an assembling unit which aligns and fixes the cathode electrode, the first insulating layer, the gate, the second insulating layer and the focusing gate with respect to each other.

3. The electron beam generator of claim 2, wherein the assembling unit comprises:
lateral supporting units on the cathode electrode; and
an upper supporting unit directly on the focusing gate,
wherein the upper supporting unit is in separable connection with the lateral supporting units.

4. The electron beam generator of claim 1, further comprising an alignment unit which aligns the cathode electrode, the first insulating layer, the second insulating layer and the focusing gate with respect to each other.

5. The electron beam generator of claim 4, the alignment unit is on one of the cathode electrode, the first insulating layer, the gate, the second insulating layer and the focusing gate.

6. The electron beam generator of claim 5, wherein the alignment unit includes alignment marks.

7. The electron beam generator of claim 6, wherein the alignment marks including a groove in the one of the cathode electrode, the first insulating layer, the gate, the second insulating layer and the focusing gate.

8. The electron beam generator of claim 4, wherein the alignment unit includes:
a plurality of alignment marks on the cathode electrode, and
through holes in the first insulating layer, the gate, the second insulating layer and the focusing gate respectively aligned with the alignment marks on the cathode electrode.

9. An X-ray generator comprising:
a container unit including a window on a side of the container unit;
an electron beam generation unit in the container unit, wherein the electron beam generation unit generates an electron beam; and
an anode in the container unit, wherein the anode generates X-rays due to the electron beam from the electron beam generation unit;
wherein the X-rays are emitted through the window of the container unit to an outside of the container unit, and
wherein the electron beam generation unit comprises the electron beam generator of claim 1.

10. The X-ray generator of claim 9, wherein the electron beam generation unit is separable from and combinable with the container unit.

11. A method of forming an electron beam generator, the method comprising:
detachably disposing a first insulating layer, a gate, a second insulating layer and a focusing gate, on a cathode electrode,
wherein the first insulating layer, the gate, the second insulating layer and the focusing gate are sequential on the cathode electrode, and
the cathode electrode, the first insulating layer, the gate, the second insulating layer and the focusing gate are individually separable from each other and combinable with each other.

12. The method of claim 11, further comprising:
disposing a first fixing unit on the cathode electrode;
disposing a second fixing unit on the focusing gate; and
detachably engaging the first fixing unit with the second fixing unit such that the first insulating layer, the gate, the second insulating layer and the focusing gate are aligned with each other and the cathode electrode, and are between the cathode electrode and the second fixing unit.

13. The method of claim 11, further comprising:
disposing a first alignment member on the cathode electrode;
disposing a second alignment member on one of the first insulating layer, the gate, the second insulating layer and the focusing gate; and
aligning the first and second aligning members with each other such that the cathode electrode, the first insulating layer, the second insulating layer and the focusing gate are aligned with respect to each other.

14. The method of claim 13, wherein the first alignment member includes a groove.

15. The method of claim 13, wherein the second alignment member includes a plurality of through holes.
